(19) United States
(12) Patent Application Publication
(10) Pub. No.: US 2025/0286638 A1
(43) Pub. Date: Sep. 11, 2025

(54) ESTABLISHMENT AND PREDICTION OF RF CALIBRATION AI MODEL

(71) Applicant: MEDIATEK INC., Hsinchu (TW)

(72) Inventors: Tsung-Yin Lu, Hsinchu (TW); WEN-CHIH wen CHEN, Hsinchu (TW); KUN-HO CHOU, Hsinchu (TW); KUN-YING LIN, Hsinchu (TW); YA-CHUN CHANG, Hsinchu (TW); An-Rong WU, Hsinchu (TW); YING-TING CHUANG, Hsinchu (TW)

(21) Appl. No.: 18/951,750

(22) Filed: Nov. 19, 2024

Related U.S. Application Data
(60) Provisional application No. 63/561,378, filed on Mar. 5, 2024.

(51) Int. Cl. H04B 17/391; H04B 17/11; H04B 17/21

(52) U.S. Cl. CPC H04B 17/3913; H04B 17/11; H04B 17/21

(57) ABSTRACT

In an aspect of the disclosure, a method, a computer-readable medium, and an apparatus are provided. The apparatus may be a computing device. The computing device receives calibration data that includes RF measurements at multiple frequency points for a band and calibration index (CID) combination. The computing device selects a subset of the frequency points as input frequency points. The computing device trains an artificial intelligence (AI) model using the calibration data. During the training, the computing device inputs RF measurements at the input frequency points to the AI model. The computing device generates predicted RF measurements for the remaining frequency points of the plurality of frequency points using the AI model. The computing device compares the predicted RF measurements to actual RF measurements in the calibration data to determine prediction errors.

### CROSS-REFERENCE TO RELATED APPLICATION(S)

This application claims the benefits of U.S. Provisional Application Ser. No. 63/561,378, entitled “ESTABLISHMENT AND PREDICTION OF RF CALIBRATION AI MODEL” and filed on Mar. 5, 2024, which is expressly incorporated by reference herein in its entirety.

### BACKGROUND

### Field

The present disclosure relates generally to radio frequency (RF) calibration of wireless communication devices, and more particularly, to techniques of using artificial intelligence models to predict measurement values from a reduced set of calibration measurements.

### Background

The statements in this section merely provide background information related to the present disclosure and may not constitute prior art.

Radio frequency (RF) calibration is a critical process in the manufacturing of wireless communication devices to ensure they meet performance specifications and operate correctly across their designated frequency bands. During RF calibration, path loss measurements must be taken at multiple frequency points and gain settings to characterize and compensate for the frequency-dependent behavior of RF components like filters, amplifiers, and antennas. Manufacturing variations and component tolerances introduce discrepancies in frequency response that need to be corrected through calibration.

The calibration process involves transmitting known test signals from calibration equipment to the device under test (DUT) through a connector or antenna interface. The DUT receives these signals and measures the received power level. Since the transmitted power is known, the path loss can be calculated as the difference between transmitted and received power. These measurements must be repeated across different gain settings to characterize the DUT's behavior under various operational modes.

There was no established method for using artificial intelligence or machine learning techniques to reduce the number of required calibration measurements while maintaining accuracy.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a computing device. The computing device receives calibration data that includes RF measurements at multiple frequency points for a band and calibration index (CID) combination. The computing device selects a subset of the frequency points as input frequency points. The computing device trains an artificial intelligence (AI) model using the calibration data. During the training, the computing device inputs RF measurements at the input frequency points to the AI model. The computing device generates predicted RF measurements for the remaining frequency points of the plurality of frequency points using the AI model. The computing device compares the predicted RF measurements to actual RF measurements in the calibration data to determine prediction errors.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 is a diagram illustrating a first technique of performing Radio Frequency (RF) calibrations across multiple frequency points and gain settings for a device under test.

FIG. 4 is a diagram illustrating a data preprocessing flow used for training an artificial intelligence model to perform radio frequency calibrations for the device under test.

FIG. 5 is a diagram illustrating a model training and evaluation flow for training an artificial intelligence model to perform radio frequency calibrations for the device under test.

FIG. 6 is a diagram illustrating the architecture of an exemplary AI model designed for performing RF calibrations of the device under test.

FIGS. 7(A) and 7(B) are a flow chart of a method for calibrating a radio frequency (RF) device.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

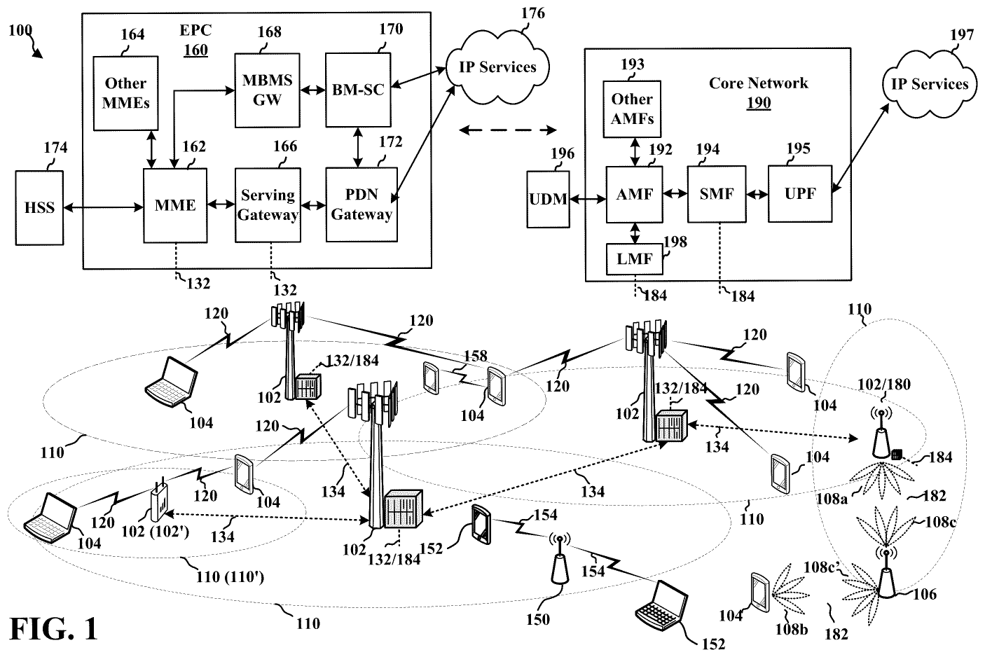

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MH2 (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (CNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

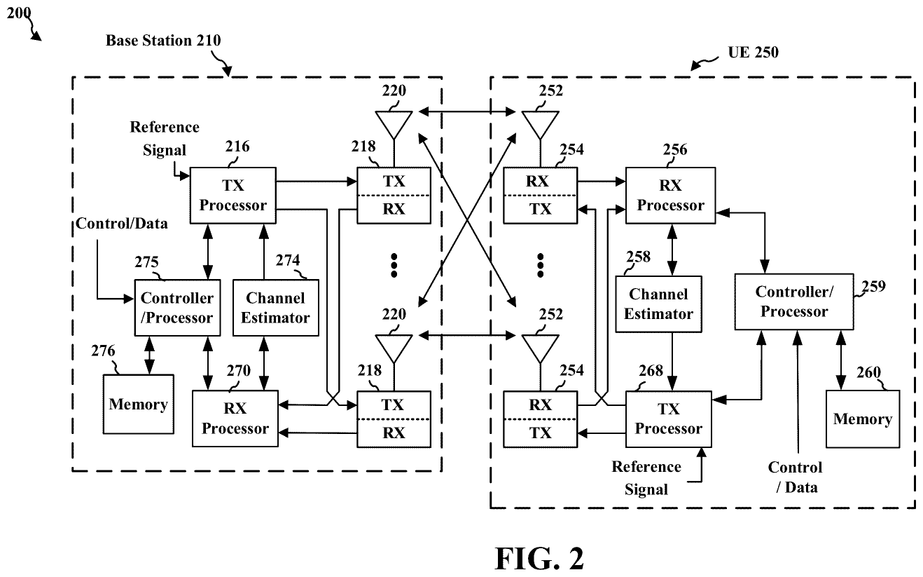

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

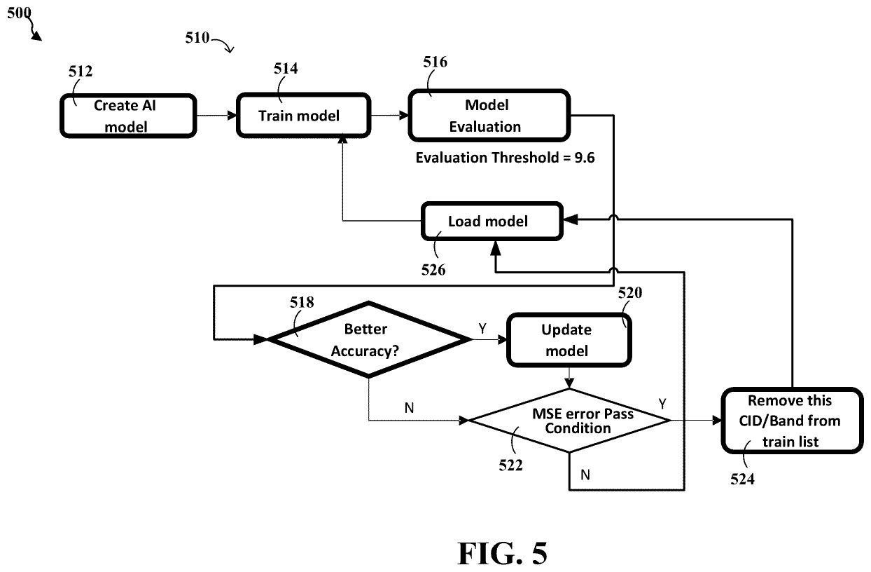

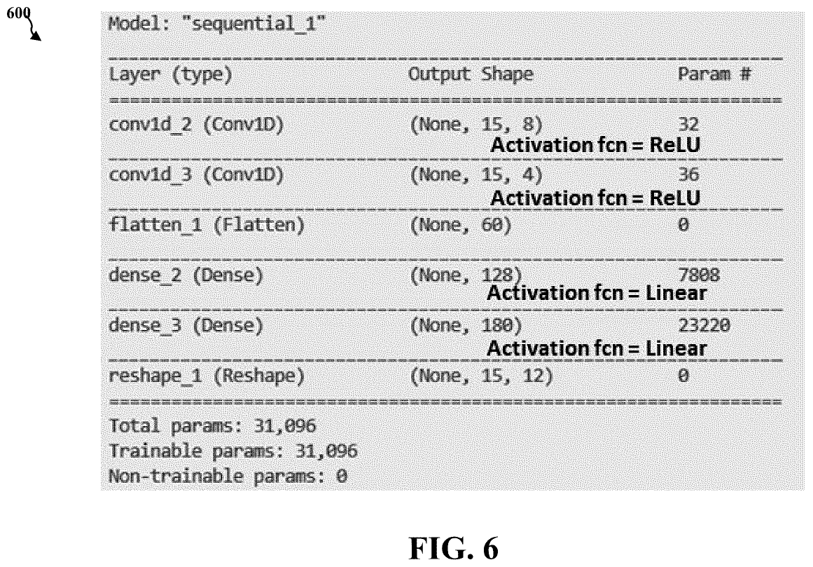

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUS). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

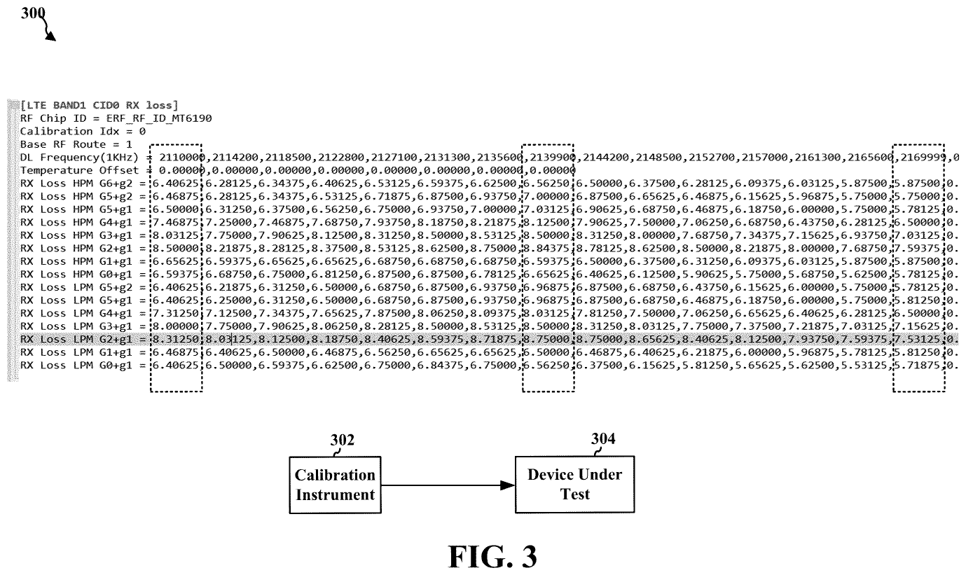

FIG. 3 is a diagram 300 illustrating a first technique of performing Radio Frequency (RF) calibrations across multiple frequency points and gain settings for a device under test (DUT) 304, which may be the UE 104. In this technique, each frequency point within the operating band is individually calibrated to ensure accurate signal transmission and reception.

The calibration process is necessary due to the frequency-dependent characteristics of RF components like filters, amplifiers, and antennas. Manufacturing variations and component tolerances can introduce discrepancies in the frequency response, which must be corrected to meet performance specifications.

To calibrate each point without an AI model, the following steps are undertaken for every frequency and gain setting. A known signal at a specific frequency fᵢ is generated by a calibration instrument 302 and transmitted through a connector or antenna interface to the DUT 304. The DUT 304 receives the signal, and the received power P_{received} at that frequency and gain setting Gⱼ is measured. The expected transmitted power P_{transmitted} is known. The path loss Lᵢⱼ for frequency fᵢ and gain setting Gⱼ is calculated using:

$${L}_{i j} = {P}_{transmitted} - {P}_{r e c e i v e d} .$$

The calculated path loss Lᵢⱼ is recorded and used to adjust the DUT 304's parameters to compensate for the loss at that specific frequency and gain setting. The above steps are repeated for all frequency points fᵢ and gain settings Gⱼ.

FIG. 3 shows that, in this example, for LTE Band 1, the downlink frequencies to be calibrated are:

$${f}_{0} = 21 \; 10000 KHz ,$$

$${f}_{1} = 21 \; 14200 KHz ,$$

$${f}_{2} = 21 \; 18500 KHz ,$$

$$⋮$$

$${f}_{14} = 21 \; 69999 KHz .$$

These frequencies span the entire operational band, requiring each to be individually calibrated.

The DUT 304 must also be calibrated across multiple gain settings to account for different operational modes. The gain settings may include High Power Mode (HPM) and Low Power Mode (LPM) with various gain indices:

### HPM Gain Settings:

$${G}_{HPM} = \{ G 6 + g 2 , G 5 + g 1 , G 4 + g 1 , G 3 + g 1 , G 2 + g 1 , G 1 + g 1 , G 0 + g 1 \} .$$

### LPM Gain Settings:

$${G}_{LPM} = \{ G 5 + g 2 , G 5 + g 1 , G 4 + g 1 , G 3 + g 1 , G 2 + g 1 , G 1 + g 1 , G 0 + g 1 \} .$$

Gain settings refer to the adjustable levels of amplification within the RF receiver circuitry of the DUT 304. These gain settings allow the device to operate effectively across a wide range of signal strengths by modifying the gain applied to the received signal. Adjusting the gain is useful to optimize the signal-to-noise ratio (SNR) and to prevent saturation or under-amplification of the receiver components.

In this example, the gain settings are organized into different modes and levels to accommodate various operational conditions:
High Power Mode (HPM): Utilized when the received signal strength is relatively low and higher amplification is necessary. Within HPM, there are multiple gain levels denoted by indices such as G6, G5, G4, etc., combined with fine-tuning steps indicated by +g1, +g2, etc.
Low Power Mode (LPM): Activated when the received signal strength is relatively high, requiring less amplification to prevent overloading the receiver. LPM also includes gain levels like G5, G4, G3, etc., with similar fine adjustments.

Each gain setting Gⱼ may correspond to a specific configuration of the receiver's variable gain amplifier (VGA) or low-noise amplifier (LNA). The gain levels (e.g., G6, G5, G4) represent coarse adjustments in amplification, while the additional increments +g1, +g2 denote finer tuning within each coarse gain level. This hierarchical gain control structure allows for precise calibration and compensation across different signal conditions and frequencies.

The data presented in FIG. 3 under entries such as “RX Loss HPM G6+g2” represent the measured path losses at specific frequencies and gain settings during the calibration process. For instance, consider the line:

$$RX Loss HPM G 6 + g 2 = 6.40625 , 6.28125 , 6.34375 , \\ 6.40625 , 6.53125 , 6.59375 , 6.625 , 6.5625 , 6.5 , \\ 6.375 , 6.28125 , 6.09375 , 6.03125 , 5.875 , 5.875 , 0$$

This sequence provides the calibrated path loss values Lᵢⱼ at each frequency point fᵢ when the DUT 304 is set to High Power Mode with gain setting G6+g2.

Each numerical value corresponds to the path loss measured at a specific downlink frequency fᵢ outlined in the calibration data, such as f₀=2110.000 MHz, f₁=2114.200 MHz, up to f₁₄=2169.999 MHz. The path loss values are in units of decibels (dB) and are recorded with high precision to capture subtle variations in the RF characteristics of the DUT 304. The sequence reflects how the path loss varies across the operational frequency band for the given gain setting G6+g2. Similarly, other entries such as “RX Loss HPM G5+g2”, “RX Loss HPM G5+g1”, “RX Loss HPM G4+g1”, etc., provide the calibrated path loss values for different gain settings within High Power Mode. Each set of data corresponds to a unique combination of gain setting and power mode, capturing the DUT 304's response under those specific conditions.

For example, the data for “RX Loss HPM G5+g2” is:

$$RX Loss HPM G 5 + g 2 = 6.46875 , 6.28125 , 6.34375 , \\ 6.53125 , 6.71875 , 6.875 , 6.9375 , 7. , 6.875 , \\ 6.65625 , 6.46875 , 6.15625 , 5.96875 , 5.75 , 5.75 , 0$$

These detailed calibration measurements are useful for adjusting the DUT 304's internal parameters to compensate for frequency-dependent losses and gains in the RF signal chain. Components such as filters, amplifiers, and antennas exhibit characteristics that vary with frequency, and the calibration data enable the device to correct for these variations during operation.

The inclusion of multiple gain settings and their respective calibration across all frequency points allows the DUT 304 to adapt to different signal environments and maintain consistent performance. By adjusting the gain setting based on the received signal strength and frequency, the device can optimize its reception quality and avoid issues such as signal distortion or saturation.

The last value in each sequence, often set to zero (e.g., the trailing ‘, 0’ in the data), may serve as a placeholder or indicate the end of the data sequence for that particular calibration setting.

The total number of calibration points N is the product of the number of frequency points N_{f} and the number of gain settings N_{g}:

$$N = {N}_{f} \times {N}_{g} .$$

For instance, with N_{f}=15 frequency points and N_{g}=15 gain settings (combining both HPM and LPM), the total number of calibration measurements required is:

$$N = 15 \times 15 = 225 .$$

Each calibration measurement involves precise instrumentation and time, contributing to an extensive calibration process.

The necessity of calibrating each frequency and gain setting arises due to the path loss variations across frequencies and operational modes. Components in the RF signal chain, such as filters and amplifiers, exhibit frequency-dependent losses and gains. Additionally, the antenna interface and other passive components introduce their own frequency responses.

By individually calibrating each point, the device's internal parameters are adjusted to compensate for these variations, ensuring that the transmitted and received signals meet the desired performance criteria across the entire operational band.

However, this exhaustive calibration approach is time-consuming and resource-intensive. It increases production time and costs, which is particularly significant in mass manufacturing scenarios.

A second technique employs linear interpolation based on golden data to reduce the number of calibration points required. This approach addresses the time-consuming nature of calibrating all frequency points and gain settings individually as described in the first technique.

In linear interpolation, only a subset of the frequency points is calibrated directly using the calibration instrument 302 and the DUT 304. These measured points serve as “golden data”-known reference points from which the path loss values for intermediate frequencies can be mathematically interpolated. For example, if path loss values L₁ and L₂ are measured at frequencies f₁ and f₂ respectively, the path loss Lₓ at an intermediate frequency fₓ can be calculated using:

$${L}_{x} = {L}_{1} + \frac{( {L}_{2} - {L}_{1} ) ( {f}_{x} - {f}_{1} )}{{f}_{2} - {f}_{1}} .$$

This technique reduces the calibration time by requiring measurements at fewer points—typically 5 to 9 points instead of all 15 frequency points for each gain setting. The remaining path loss values are computed through interpolation between the measured points. For instance, in the LTE Band 1 example, instead of measuring all frequencies from 2110.000 MHz to 2169.999 MHz, measurements might be taken at selected frequencies, with intermediate values calculated through interpolation.

The linear interpolation approach makes an assumption about the linearity of path loss variation between measured points. While this assumption may be reasonable for many RF systems where the frequency response varies smoothly, it can introduce errors if the actual response contains sharp variations or nonlinearities between the measured points. The accuracy of this method depends on how well the selected measurement points capture the true frequency response characteristics of the DUT 304. The interpolation technique offers a compromise between calibration time and accuracy.

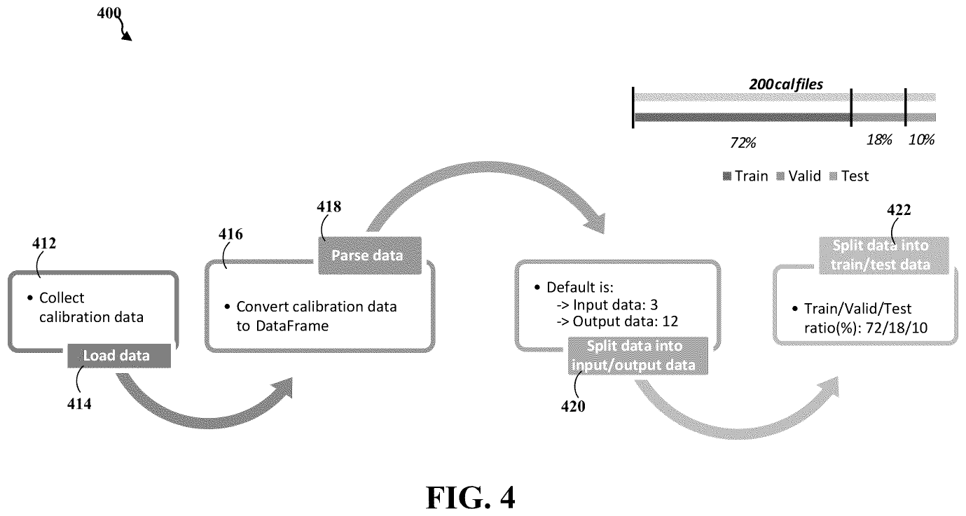

FIG. 4 is a diagram 400 illustrating a data preprocessing flow 410 used for training an artificial intelligence (AI) model to perform radio frequency (RF) calibrations for the device under test (DUT) 304. This third technique aims to reduce the number of required calibration measurements by predicting path loss values at various frequency points and gain settings based on a limited set of measurements, thereby decreasing calibration time and effort.

The calibration process using the AI model is divided into two main phases: 1. Data Preprocessing; 2. Model Training and Evaluation (described infra).

In the data preprocessing flow 410, in operation 412, calibration data is collected. Approximately 200 calibration files are gathered, each containing detailed calibration measurements similar to those in FIG. 3. Each calibration file corresponds to a specific combination of frequency band (e.g., LTE Band 1), calibration index (CID), and includes path loss measurements across multiple frequency points and gain settings for the DUT 304.

In operation 414, the collected calibration data is loaded into the computing system's memory for processing. This involves reading the calibration files and initializing data structures to store the data.

In operation 416, the calibration data is converted into a dataFrame. For example, pandas DataFrame in the Python programming language may be used. Pandas is a powerful data manipulation library that provides efficient data structures and functions for handling large datasets. By converting the calibration data into a DataFrame, the data can be easily manipulated, filtered, and analyzed in subsequent steps.

In operation 418, the data is parsed to prepare it for input into the AI model. Specifically, the data is organized such that a subset of the measured path loss values serves as the input features, and the remaining values serve as the output targets that the AI model will learn to predict.

By default, the input data includes the path loss measurements at three specific frequency points, representing the low, middle, and high frequencies of the operational band. For example, these frequencies may be:

f_{low}=2110000 KHz,

f_{mid}=2139900 KHz,

f_{high}=2169999 KHz.

These three frequencies are selected because they capture the path loss characteristics at the extremities and midpoint of the band. The corresponding path loss measurements at these frequencies are extracted from the data and used as the input features X for the AI model.

The output data includes the path loss measurements at the remaining 12 frequency points within the band. These path loss values are the target outputs Y that the AI model aims to predict based on the input features. By learning the relationship between the path loss at the three selected frequencies and the other frequencies, the AI model can generalize and predict the path loss across the entire band.

In operation 420, the data is split into input and output datasets. The pandas DataFrame is partitioned into two subsets: one containing the input features X (path loss measurements at the three selected frequencies) and the other containing the output targets Y (path loss measurements at the remaining 12 frequencies).

In operation 422, the data is further split into subsets for training, validation, and testing of the AI model. The total dataset of approximately 200 calibration files is divided using a ratio of 72% for training, 18% for validation, and 10% for testing. Specifically, about 144 calibration files are used for training the AI model, 36 files for validation, and 20 files for testing.

The training set is used to teach the model the underlying patterns in the data. The validation set is used during training to monitor the model's performance on unseen data, allowing for adjustments such as hyperparameter tuning and preventing overfitting. The test set, which the model has not seen during training or validation, is used to assess the final performance of the model and its ability to generalize to new, unseen data.

For each combination of frequency band and calibration index (CID), a separate AI model may be trained. This is because the path loss characteristics can vary significantly between different bands and CIDs. Therefore, the data preprocessing and subsequent model training are performed for each band and CID combination, resulting in multiple AI models specialized for predicting path loss within specific operational conditions.

By performing these data preprocessing steps, the calibration data is organized and prepared for effective training of the AI model. The goal is to enable the model to learn the mapping from the input features (path loss at selected frequencies) to the output targets (path loss at other frequencies), thereby reducing the need for full calibration across all frequency points and gain settings.

FIG. 5 is a diagram 500 illustrating a model training and evaluation flow 510 for training an artificial intelligence (AI) model to perform radio frequency (RF) calibrations for the device under test (DUT) 304. This flow 510 follows the data preprocessing flow 410 described in FIG. 4 and aims to create specialized AI models for each combination of frequency band and calibration index (CID).

In operation 512, an AI model is created for a specific combination of frequency band and CID. In one example, the AI model architecture includes two convolutional layers followed by a flatten operation and fully connected layers. The convolutional layers extract features from the input data, capturing underlying patterns in the path loss measurements. The first convolutional layer applies filters to the input data to detect simple patterns, and the second layer builds upon these to capture more complex features. An activation function, such as the Rectified Linear Unit (ReLU), is used after each convolutional layer to introduce non-linearity.

After the convolutional layers, the data is passed through a flatten layer, which reshapes the multi-dimensional output into a one-dimensional array suitable for the fully connected layers. The model then includes one or more fully connected (dense) layers that process the flattened data to generate the final output. The activation function for the dense layers may be linear, allowing the model to estimate continuous path loss values.

The input to the AI model contains path loss measurements at selected frequency points within the operational band. These frequencies typically represent the low (f_{low}), middle (f_{mid}), and high (f_{high}) frequencies of the band, capturing essential characteristics of the path loss over the frequency spectrum. For instance, in LTE Band 1, these frequencies might be:

f_{low}=2110000 KHz,

f_{mid}=2139900 KHz,

f_{high}=2169999 KHz.

The output of the model is the predicted path loss values at the remaining twelve frequency points within the band.

In operation 514, the AI model undergoes training using the preprocessed calibration data corresponding to the specific band and CID. Prior to training, the floating-point path loss values are quantized by multiplying them by 32 and converting them to integers. This quantization reduces computational complexity and accelerates the training process by simplifying arithmetic operations and improving convergence characteristics.

The training process utilizes a batch size of 200 samples and is conducted over 2000 epochs. The loss function employed is the Mean Square Error (MSE), defined as:

$$M S E = \frac{1}{n} {\sum }_{i = 1}^{n} {( {y}_{i} - {\hat{y}}_{i} )}^{2} ,$$

where yᵢ represents the ground truth path loss values, ŷᵢ represents the predicted values from the model, and n is the number of samples. The optimizer used may be Adam, an adaptive learning rate optimization algorithm, with an initial learning rate of 0.001.

To enhance the model's generalization and prevent overfitting, techniques such as early stopping, ReduceLROnPlateau, and L2 regularization are employed. Early stopping monitors the validation loss and halts training when improvements become negligible. ReduceLROnPlateau reduces the learning rate when a metric has stopped improving, allowing the model to fine-tune weights during later stages of training. L2 regularization adds a penalty term to the loss function to discourage large weights, promoting simpler models.

In operation 516, the model's performance is evaluated against a threshold criterion to determine the success of the training. The evaluation threshold is set at 9.6, corresponding to the original acceptable error of 0.3 dB multiplied by the quantization factor of 32. This scaling aligns the threshold with the quantized data.

The evaluation involves calculating the absolute difference between the predicted path loss values and the ground truth measurements, multiplied by 32 due to quantization:

$$Error = \vert {\hat{y}}_{i} - {y}_{i} \vert \times 32.$$

If the error for any data point exceeds the threshold of 9.6, it is considered a significant deviation. The error rate is computed as:

$$Error rate = \frac{\# ( Errors \geq 9.6 )}{\# Total Data Points} ,$$

where #(Errors≥9.6) is the number of data points where the error exceeds the threshold.

In operation 518, the flow determines whether the current training iteration has achieved better accuracy compared to previous iterations for the specific band and CID. This iterative process allows for continuous improvement of the model. If an improved accuracy is observed—indicated by a lower MSE or error rate—the model parameters are updated accordingly in operation 520.

If no improvement is detected, the flow proceeds to operation 522, where it checks whether the MSE has converged, suggesting that additional training would not yield significant gains. Convergence is assessed based on criteria such as negligible change in MSE over successive epochs or meeting a predefined MSE threshold.

If the MSE has converged, the flow advances to operation 524. In this step, the current band and CID combination is removed from the training list, indicating that a satisfactory model has been developed for this specific combination. This prevents unnecessary further training and allows resources to be allocated to other combinations.

If the MSE has not converged, the flow returns to operation 526, where the model is reloaded for another training iteration. Adjustments may be made to the training process, such as modifying hyperparameters or reinitializing the learning rate, to facilitate convergence in subsequent iterations. This cyclical process ensures that each model is trained to an optimal level before finalization.

Operations 512 through 526 are repeated for each band and CID combination. For example, if there are ten different combinations, the process may result in ten distinct AI models, each tailored to its specific band and CID. While the initial model architecture remains consistent across combinations, the training data and resulting parameters differ, reflecting the unique path loss characteristics associated with each combination.

By employing specialized models for each band and CID, the calibration system maintains high prediction accuracy across various operational conditions. This method reduces the number of required calibration measurements. Instead of calibrating all fifteen frequency points for each gain setting, the calibration instrument 302 only needs to measure path loss at three selected frequencies per gain setting for each band and CID combination. The AI models then predict the path loss values at the remaining frequencies.

FIG. 6 is a diagram 600 illustrating the architecture of an exemplary AI model designed for performing RF calibrations of the DUT 304. In this example, the model follows a sequential structure implemented using the Keras framework with TensorFlow as the backend. The model architecture includes five main layers plus a reshape layer. The first two layers are one-dimensional convolutional layers (Conv1D) that process the input data, which contain path loss measurements at three selected frequency points for each gain setting. The first Conv1D layer, denoted as convld_2, expands the input into 8 channels while maintaining the temporal dimension of 15 time steps, utilizing 32 trainable parameters. This layer employs the Rectified Linear Unit (ReLU) activation function to introduce non-linearity into the model.

The second Conv1D layer, convld_3, further processes the data by reducing the number of channels to 4 while preserving the temporal dimension. This layer contains 36 trainable parameters and also uses the ReLU activation function. The two convolutional layers work together to extract relevant features from the path loss measurements across different frequencies and gain settings.

Following the convolutional layers, a flatten_1 layer transforms the three-dimensional output into a one-dimensional vector of length 60. This flattening operation preserves all information while restructuring it into a format suitable for the subsequent dense layers.

The first dense layer, dense_2, expands the flattened representation to 128 outputs with 7,808 trainable parameters. This layer uses a linear activation function to maintain the continuous nature of the path loss predictions. The second dense layer, dense_3, further processes the data to produce 180 outputs with 23,220 trainable parameters, also utilizing a linear activation function. The final reshape_1 layer reorganizes the 180 outputs into a 15×12 matrix, corresponding to the predicted path loss values at the remaining 12 frequency points for each of the 15 gain settings. This reshape operation does not require any trainable parameters.

In total, the model contains 31,096 trainable parameters and no non-trainable parameters. The relatively small number of parameters helps prevent overfitting while maintaining sufficient complexity to capture the underlying relationships in the RF calibration data.

The model is trained using a batch size of 200 samples over 2000 epochs. The Mean Square Error (MSE) loss function measures the prediction accuracy by computing the average squared difference between predicted and actual path loss values. The Adam optimizer, with an initial learning rate of 0.001, adjusts the model parameters during training to minimize this loss.

To address potential overfitting, the model employs several regularization techniques. Early stopping monitors the validation loss and halts training when improvements become minimal. The ReduceLROnPlateau mechanism automatically reduces the learning rate when the loss plateaus, enabling finer weight adjustments in later training stages. Additionally, L2 regularization adds a penalty term to the loss function that discourages large weight values, promoting a simpler and more generalizable model.

The model's architecture was determined through empirical testing, with the two convolutional layers found sufficient for extracting relevant features from the relatively simple path loss patterns. The combination of convolutional and dense layers enables the model to learn both local frequency-dependent characteristics and global relationships across different gain settings, resulting in accurate path loss predictions while requiring measurements at only three frequency points instead of all fifteen points during the calibration process.

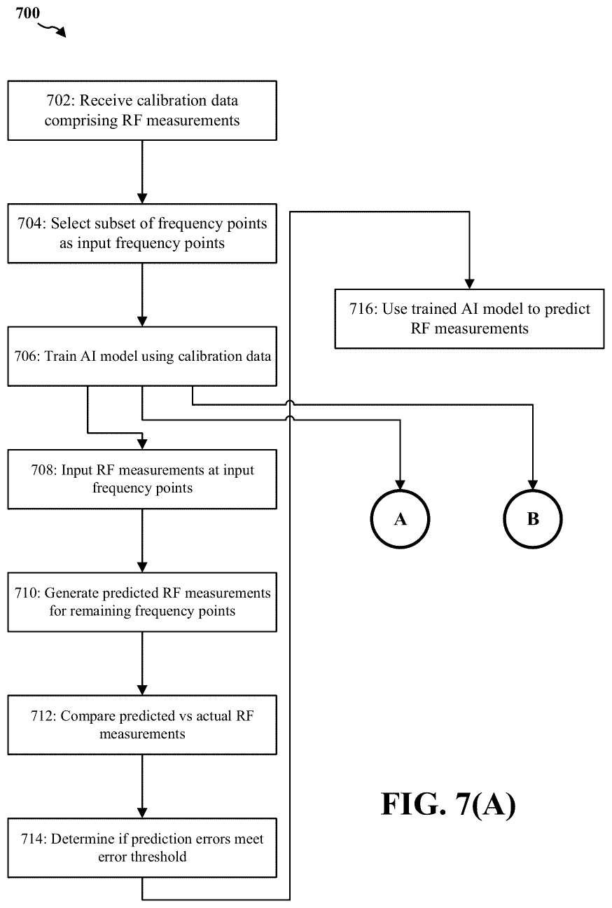

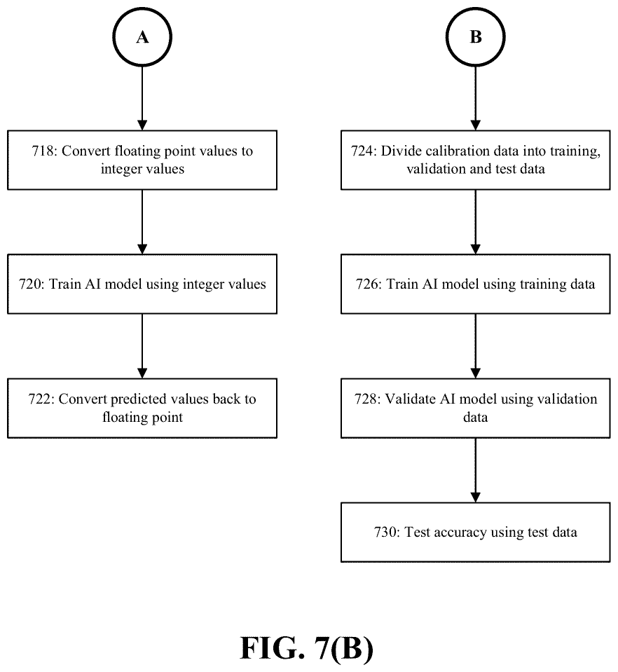

FIGS. 7(A) and (7B) are a flow chart 700 of a method for calibrating a radio frequency (RF) device. The method may be performed by a computing device. In operation 702, the computing device receives calibration data comprising RF measurements at a plurality of frequency points for a band and calibration index (CID) combination. In operation 704, the computing device selects a subset of the plurality of frequency points as input frequency points. The input frequency points are fewer than the remaining frequency points.

In operation 706, the computing device trains an artificial intelligence (AI) model using the calibration data. To train the AI model, in operation 708, the computing device inputs RF measurements at the input frequency points to the AI model. In operation 710, the computing device generates predicted RF measurements for remaining frequency points of the plurality of frequency points using the AI model. In operation 712, the computing device compares the predicted RF measurements to actual RF measurements in the calibration data to determine prediction errors.

In operation 714, the computing device determines whether the prediction errors meet an error threshold. To determine whether the prediction errors meet the error threshold, the computing device calculates a mean error and standard deviation of the prediction errors, determines whether a sum of the mean error and three times the standard deviation is below a threshold value, and determines whether a maximum prediction error is below an absolute error limit. In operation 716, when the prediction errors meet the error threshold, the computing device uses the trained AI model to predict RF measurements for the remaining frequency points based on RF measurements at only the input frequency points.

To train the AI model, in operation 718, the computing device converts floating point calibration data values to integer values by multiplying by a scaling factor. In certain configurations, the scaling factor is 32. In operation 720, the computing device trains the AI model using the integer values. In operation 722, the computing device converts predicted values from the AI model back to floating point values by dividing by the scaling factor.

In certain configurations, the AI model comprises one or more convolutional neural network layers, a flatten layer, and one or more fully connected layers.

To train the AI model, in operation 724, the computing device divides the calibration data into training data, validation data, and test data according to predetermined ratios. In operation 726, the computing device trains the AI model using the training data. In operation 728, the computing device validates the AI model using the validation data. In operation 730, the computing device tests accuracy of the AI model using the test data.

In certain configurations, the RF measurements are path loss measurements for multiple gain modes.

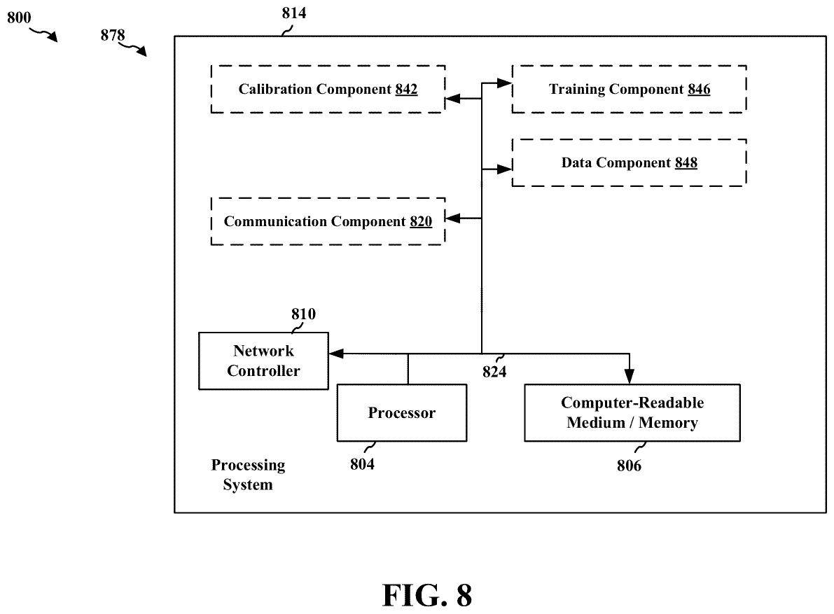

FIG. 8 is a diagram 800 illustrating an example of a hardware implementation for an apparatus 878 employing a processing system 814. The apparatus 878 may implement a calibration component 842, a training component 846, and a data component 848. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by a processor 804, a network controller 810, and a computer-readable medium/memory 806. The bus 824 may also link various other circuits such as timing sources, peripherals, voltage regulators, and power management circuits, which are well known in the art, and therefore, will not be described any further.

The processing system 814 may be coupled to the network controller 810. The network controller 810 provides a means for communicating with various other apparatus over a network. The network controller 810 receives a signal from the network, extracts information from the received signal, and provides the extracted information to the processing system 814, specifically a communication component 820 of the apparatus 878. In addition, the network controller 810 receives information from the processing system 814, specifically the communication component 820, and based on the received information, generates a signal to be sent to the network. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system further includes the calibration component 842, the training component 846, and the data component 848. The components may be software components running in the processor 804, resident/stored in the computer readable medium/memory 806, one or more hardware components coupled to the processor 804, or some combination thereof.

The apparatus 878 may include means for performing operations as described supra referring to FIG. 7. The aforementioned means may be one or more of the aforementioned components of the apparatus 878 and/or the processing system 814 of the apparatus 878 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of calibrating a radio frequency (RF) device, comprising:
receiving calibration data comprising RF measurements at a plurality of frequency points for a band and calibration index (CID) combination;
selecting a subset of the plurality of frequency points as input frequency points; and
training an artificial intelligence (AI) model using the calibration data, wherein the training comprises:
inputting RF measurements at the input frequency points to the AI model;
generating predicted RF measurements for remaining frequency points of the plurality of frequency points using the AI model; and
comparing the predicted RF measurements to actual RF measurements in the calibration data to determine prediction errors.

2. The method of claim 1, wherein the input frequency points are fewer than the remaining frequency points.

3. The method of claim 1, wherein the training further comprises:
determining whether the prediction errors meet an error threshold; and
when the prediction errors meet the error threshold, using the trained AI model to predict RF measurements for the remaining frequency points based on RF measurements at only the input frequency points.

4. The method of claim 3, wherein determining whether the prediction errors meet the error threshold comprises:
calculating a mean error and standard deviation of the prediction errors;
determining whether a sum of the mean error and three times the standard deviation is below a threshold value; and
determining whether a maximum prediction error is below an absolute error limit.

5. The method of claim 1, wherein the training further comprises:
converting floating point calibration data values to integer values by multiplying by a scaling factor;
training the AI model using the integer values; and
converting predicted values from the AI model back to floating point values by dividing by the scaling factor.

6. The method of claim 5, wherein the scaling factor is 32.

7. The method of claim 1, wherein the AI model comprises:
one or more convolutional neural network layers;
a flatten layer; and
one or more fully connected layers.

8. The method of claim 1, wherein the training comprises:
dividing the calibration data into training data, validation data, and test data according to predetermined ratios;
training the AI model using the training data;
validating the AI model using the validation data; and
testing accuracy of the AI model using the test data.

9. The method of claim 1, wherein:
the RF measurements are path loss measurements for multiple gain modes.

10. An apparatus for calibrating a radio frequency (RF) device, comprising:
a memory; and
at least one processor coupled to the memory and configured to:
receive calibration data comprising RF measurements at a plurality of frequency points for a band and calibration index (CID) combination;
select a subset of the plurality of frequency points as input frequency points; and
train an artificial intelligence (AI) model using the calibration data, wherein to train the AI model, the at least one processor is further configured to:
input RF measurements at the input frequency points to the AI model;
generate predicted RF measurements for remaining frequency points of the plurality of frequency points using the AI model; and
compare the predicted RF measurements to actual RF measurements in the calibration data to determine prediction errors.

11. The apparatus of claim 10, wherein the input frequency points are fewer than the remaining frequency points.

12. The apparatus of claim 10, wherein the at least one processor is further configured to:
determine whether the prediction errors meet an error threshold; and
when the prediction errors meet the error threshold, use the trained AI model to predict RF measurements for the remaining frequency points based on RF measurements at only the input frequency points.

13. The apparatus of claim 12, wherein to determine whether the prediction errors meet the error threshold, the at least one processor is configured to:
calculate a mean error and standard deviation of the prediction errors;
determine whether a sum of the mean error and three times the standard deviation is below a threshold value; and
determine whether a maximum prediction error is below an absolute error limit.

14. The apparatus of claim 10, wherein the at least one processor is further configured to:
convert floating point calibration data values to integer values by multiplying by a scaling factor;
train the AI model using the integer values; and
convert predicted values from the AI model back to floating point values by dividing by the scaling factor.

15. The apparatus of claim 14, wherein the scaling factor is 32.

16. The apparatus of claim 10, wherein the AI model comprises:
one or more convolutional neural network layers;
a flatten layer; and
one or more fully connected layers.

17. The apparatus of claim 10, wherein to train the AI model, the at least one processor is configured to:
divide the calibration data into training data, validation data, and test data according to predetermined ratios;
train the AI model using the training data;
validate the AI model using the validation data; and
test accuracy of the AI model using the test data.

18. The apparatus of claim 10, wherein:
the RF measurements are path loss measurements for multiple gain modes.

19. A computer-readable medium storing computer executable code for calibrating a radio frequency (RF) device, comprising code to:
receive calibration data comprising RF measurements at a plurality of frequency points for a band and calibration index (CID) combination;
select a subset of the plurality of frequency points as input frequency points; and
train an artificial intelligence (AI) model using the calibration data, wherein to train the AI model, the code is further configured to:
input RF measurements at the input frequency points to the AI model;
generate predicted RF measurements for remaining frequency points of the plurality of frequency points using the AI model; and
compare the predicted RF measurements to actual RF measurements in the calibration data to determine prediction errors.

20. The computer-readable medium of claim 19, wherein the input frequency points are fewer than the remaining frequency points.
